(19) United States
(12) Patent Application Publication
(10) Pub. No.: US 2022/0236841 A1
(43) Pub. Date: Jul. 28, 2022

(54) GOODS MANAGEMENT METHOD

(71) Applicant: Myung Hoon KIM, Goyang-si (KR)

(72) Inventors: Myung Hoon KIM, Goyang-si (KR); Hee Seo KIM, Goyang-si (KR)

(21) Appl. No.: 17/614,406

(22) PCT Filed: May 19, 2020
(86) PCT No.: PCT/KR2020/006528

§ 371 Date: Nov. 26, 2021

(30) Foreign Application Priority Data
Jul. 30, 2019 (KR) 10-2019-0092090

(51) Int. Cl. G06F 3/0482; G06Q 10/08; G06F 3/0484

(52) U.S. Cl. CPC G06F 3/0482; G06F 3/0484; G06Q 10/087

(57) ABSTRACT

The present invention relates to a method of managing articles. A method of managing articles according to one embodiment of the present invention comprises: a step A of receiving an input of selecting a photo or video of the article or the storage place and an upper node to which a node on which the photo or video of the article or the storage place of the article is to be displayed; a step B of generating node information of the node on which the photo or video is to be displayed using node information of the upper node, and storing the photo or video and the node information of the node on which the photo or video is to be displayed; a step C of displaying the photo or video input on the node on which the photo or video input is to be displayed, using the node information of the upper node and the node information of the node on which the photo or video is to be displayed, and a step D of performing the steps A to C repeatedly for each of the plurality of the articles and the plurality of the storage places, wherein the step C includes displaying a plurality of nodes on which photos or videos for the plurality of the articles and the plurality of the storage places are displayed in a tree structure, using the node information of the nodes on which the photos or videos for the plurality of the articles and the plurality of the storage places are to be displayed.

### FIELD OF THE INVENTION

The present invention relates to a method for managing articles, and more specifically, to a method for managing articles capable of easily identifying storage places of the article and managing various kinds of articles.

### BACKGROUND OF THE INVENTION

In general, various kinds of articles such as household goods and clothing are divided and stored in different spaces such as drawers, cabinets, and closets located in specific places such as Living Rooms, bedrooms, bathrooms, and warehouse. A user finds and uses the articles stored in the various places when necessary.

However, in case of items that are not frequently used and only used in certain temporary circumstances, the user easily forgets the location of the article. Thus, it is difficult to find the item, and the user may be required to bear unnecessary costs for duplicate purchases. In addition, when item is stored for a long period of time, the item is not able to fully perform its function, and thus, the purchased items cannot be used properly and needed to be discarded.

To solve these problems, various methods for easily finding items stored in a specific location have been introduced.

For example, in Korean Patent Publication No. 10-2009-0001521, titled “Goods Box System”, published on January 9, 2009, an RFID card is installed on a storage box, and the type and quantity of stored parts are saved. Through reading and modifying the information of the RFID card, a user can identify the contents of the storage box without directly seeing the inside of the storage box. In addition, Korean Patent Publication No. 10-2006-0035711, titled “Storage Box Equipped with RFID Card for Ship Parts”, published on 26, 2006, discloses a technology for identifying the type and quantity of ship parts based on RF tags attached to the parts stored in a storage box.

In addition, recently, as smart phones are widely used, a method for managing articles using smart phones has been introduced. For example, in Korean Patent Application Publication No. 10-2016-0020301, titled “System and Method for Managing Information in Storage Box Using Smart Terminal”, published on Feb. 23, 2016, an NFC tag that stores storage box information and article information stored in the storage box is attached to the storage box, and a user can check article information using the NFC module of a smart phone.

However, the technologies disclosed above require wireless tag such as RF tag or NFC tag to be attached to the storage box or the article stored in the storage box and needed to be checked the information of the article using wireless recognition technology. In that a wireless tag must be attached to each item being stored, the process is cumbersome, and installation and maintenance costs increase. In case of attaching a wireless tag to an article itself, there is a limitation in the types of articles to which the tag can be attached.

Accordingly, there is a need for a method for managing articles that not only can easily identify the storage place of the article, but can also easily manage various types of articles.

### DETAILED DESCRITION OF THE INVENTION

### Technical Problems

The present invention is devised to solve the above problems. The objective of the present invention is to provide a method of managing articles that not only can a user easily identify the storage place of the article, but can also easily manage various types of articles, by taking actual photos or videos of the articles and storage places of the articles and managing the plurality of photos or videos in a tree structure.

The technical problem of the present invention is not limited to those mentioned above, and another technical problem that is not mentioned will be clearly understood by one skilled in the art based on the following description.

### SUMMARY OF THE INVENTION

To achieve the objects above, a method of managing articles according to one embodiment of the present invention comprises: a step A of receiving an input of selecting a photo or video of the article or the storage place and an upper node to which a node on which the photo or video of the article or the storage place of the article is to be displayed; a step B of generating node information of the node on which the photo or video is to be displayed using node information of the upper node, and storing the photo or video and the node information of the node on which the photo or video is to be displayed; a step C of displaying the photo or video input on the node on which the photo or video input is to be displayed, using the node information of the upper node and the node information of the node on which the photo or video is to be displayed, and a step D of performing the steps A to C repeatedly for each of the plurality of the articles and the plurality of the storage places, wherein the step C includes displaying a plurality of nodes on which photos or videos for the plurality of the articles and the plurality of the storage places are displayed in a tree structure, using the node information of the nodes on which the photos or videos for the plurality of the articles and the plurality of the storage places are to be displayed.

In this instance, the step A may include: a step A-1 of receiving an input, by the user input unit from a user, of selecting a photo or video displayed on an upper node to which a node on which a photo or video of an article or a storage place of the article is to be displayed, is to be connected as a lower node, and a step A-2 of receiving an input, by the user input unit, of an actual photo or video of the article or the storage place that is captured by the image capturing unit, or that was previously captured using the image capturing unit and stored in the storage unit;

In addition, the step C may further include a step C-2 of receiving an input, by the user input unit, of selecting a photo or video displayed on a first node among the plurality of the nodes on which the photos or videos for the plurality of the articles and the plurality of the storage places are displayed, in the tree structure, and a step C-3 of displaying, by the display unit, the photo or video displayed on the first node and a photo or video displayed on at least one of lower node connected to the first node, in an emphasized form.

Meanwhile, the method of managing articles may further comprise the following steps of: after the step D, a step E of switching a display mode, by the control unit, for the plurality of the nodes displayed in the tree structure based on a user's input through the user input unit, and subsequently displaying, by the display unit, the photos or videos for the plurality of the articles and the plurality of the storage places according to the switched display mode, wherein the step E includes: a step E-1 of switching the display mode, by the control unit, for the photos or videos of the plurality of the articles and the plurality of the storage places to a first mode based on a user's input through the user input unit; a step E-2 of displaying, by the display unit, a photo or video displayed on at least one node that is located at a highest level among the plurality of the nodes displayed in the tree structure, and a step E-3 of displaying, by the display unit, a photo or video displayed on at least one lower node that is connected to a selected node by a user's input through the user input unit among at least one node located at a certain level among all level including the highest level in the tree structure.

Furthermore, the method of managing articles may further comprise the following steps of: after the step D, a step F of switching a display mode, by the control unit, for the plurality of the nodes displayed in the tree structure based on a user's input through the user input unit, and subsequently displaying, by the display unit, the photos or videos for the plurality of the articles and the plurality of the storage places according to the switched display mode, wherein the step F includes: a step F-1 of switching a display mode, by the control unit, for a photo or video displayed on a first node selected by the user, among the plurality of the nodes on which the photos or videos of the plurality of the articles and the plurality of the storage places are displayed, to a second mode based on the user's input through the user input unit, and a step F-2 of displaying, by the display unit, a photo or video displayed on at least one upper node that is connected to the first node and the photo or video displayed on the first node in order of level.

Moreover, the method of managing articles may further comprise the following steps of: after the step D, a step G of switching a display mode, by the control unit, for the plurality of the nodes displayed in the tree structure based on a user's input through the user input unit, and subsequently displaying, by the display unit, the photos or videos for the plurality of the articles and the plurality of the storage places according to the switched display mode, wherein the step G includes: a step G-1 of switching a display mode, by the control unit, for a photo or video displayed on a first node selected by the user, among the plurality of the nodes on which the photos or videos of the plurality of the articles and the plurality of the storage places are displayed, to a third mode based on a user's input through the user input unit, and a step G-2 of displaying, by the display unit, the photo or video displayed on the first node in a full screen, and a step G-3 of switching to and displaying, by the display unit, a photo or video displayed on a node that is adjacent to the first node in a full screen based on a user's input through the user input unit.

In this case, in the step G-2 and the step G-3, an identification mark may indicate whether a node that can be switched with the node on which the photo or video is displayed in the full screen, exists or not in a vertical and horizontal direction, and may be provided on the top, the bottom, the left, and the right of the photo or video that is displayed in the full screen of the display unit.

Meanwhile, the method of managing articles may further comprise the following steps of: after the step D, a step H of editing a part of the plurality of the nodes displayed in the tree structure based on a user's input through the user input unit, and sequentially, displaying a photo or video for an article and a storage place according to node information of the edited part,

wherein the step H includes: a step H-1 of changing an upper node, by the control unit, of a first node selected by a user, among the plurality of the nodes on which the photos or videos of the plurality of the articles and the plurality of the storage places are displayed based on a user's input through the user input unit; a step H-2 of changing node information, by the control unit, of the first node using node information of a changed upper node, and storing, by the storage unit, the changed node information of the first node, and a step H-3 of displaying, by the display unit, the photos or videos for the plurality of the articles and the plurality of the storage places using node information of the changed upper node and changed node information of the first node.

In addition, the method of managing articles may further comprise the following steps of: after the step D, a step I of editing a part of the plurality of the nodes displayed in the tree structure based on a user's input through the user input unit, and sequentially, displaying a photo or video for an article and a storage place according to node information of the edited part, wherein the step H includes: a step I-1 of copying a photo or video, by the control unit, of a first node selected by a user, among the plurality of the nodes on which the photos or videos of the plurality of the articles and the plurality of the storage places are displayed based on a user's input through the user input unit; creating a second node with the copied photo or video, and changing an upper node of the second node; a step 1-2 of changing node information of the second node using node information of the changed upper node, and storing, by the storage unit, the changed node information of the second node, and a step 1-3 of displaying, by the display unit, the photos or videos for the plurality of the articles and the plurality of the storage places using the changed node information of the changed upper node and the changed node information of the second node.

Besides, the method of managing articles may further comprise the following steps of: after the step D, a step J of editing a part of the plurality of the nodes displayed in the tree structure based on a user's input through the user input unit, and sequentially, displaying a photo or video for an article and a storage place according to node information of the edited part,

wherein the step J includes: a step J-1 of copying a photo or video, by the control unit, of a first node selected by a user, among the plurality of the nodes on which the photos or videos of the plurality of the articles and the plurality of the storage places are displayed based on a user's input through the user input unit; creating a second node with the copied photo or video, and changing an upper node of the second node; a step J-2 of changing node information of the second node using node information of the changed upper node, and storing, by the storage unit, the changed node information of the second node; a step J-3 of, in case that a lower node connected to the first node exists, copying, by the control unit, a photo or video displayed on at least one of the lower node connected to the first node, creating at least one third node to be connected to the second node, changing node information of the at least one third node using the changed node information of the second node, and storing, by the storage unit, the changed node information of the third node, and a step J-4 of displaying, by the display unit, the photos or videos for the plurality of the articles and the plurality of the storage places using the changed upper information of the upper node, the changed node information of the second node, and the changed node information of the at least one third node.

Meanwhile, the method of managing articles may further comprise the following steps of: after the step D, a step K-1 of receiving an input, by the user input unit from the user, of selecting a symbol tag that indicates a state of an article in a photo or video displayed on a first node among the plurality of the nodes on which the photos or videos of the plurality of the articles and the plurality of the storage places are displayed; a step K-2 of updating, by the control unit, the photo or video displayed on the first node by inserting the symbol tag into the photo or video displayed on the first node, or creating tag information for the symbol tag selected for the photo or video displayed on the first node, and a step K-3 of updating node information of the first node using the updated photo or video or the tag information, and sequentially storing, by the storage unit, the node information of the first node.

Additionally, the method of managing articles may further comprise the following steps of: after the step D, a step L-1 of receiving an input, by the user input unit from the user, of selecting a photo or video displayed on a first node among the plurality of the nodes on which the photos or videos of the plurality of the articles and the plurality of the storage places are displayed, and a step L-2 of updating, by the control unit, node information of the first node by inserting a notification tag for reminder function of an article shown in the photo or video displayed on the first node, and sequentially, storing, by the storage unit, the node information of the first node.

Other embodiments are included in the detailed description and drawings.

### TECHNICAL EFFECTS OF THE INVENTION

According to a method for managing articles according to one embodiment of the present invention, the method not only can a user easily identify the storage place of the articles, but can also easily manage various types of articles, by taking an actual photo or video of the articles and the storage places of the articles and managing the plurality of photos or videos of the articles and the storage places in a tree structure.

In addition, according to a method for managing article according to one embodiment of the present invention, by displaying a plurality of photos or videos of the articles and the storage places of the articles in various display modes, it is easier to search the articles in different conditions.

Furthermore, according to a method for managing article according to one embodiment of the present invention, a part of a plurality of photos or videos of the article and the storage places of the article can be moved, copied, and deleted in a layered unit of a tree structure, thereby allowing a user to add and manage the articles more easily.

Moreover, according to a method for managing article according to one embodiment of the present invention, by inserting symbol tags into articles and setting certain properties on some of the articles, a user can more easily perform the processes of adding and managing the articles.

In addition, according to a method for managing article according to one embodiment of the present invention, by inserting a notification tag into an article and setting a reminder function for the article, a user can more easily perform the processes of adding and managing the articles.

The effects of the present invention are not limited to the effects mentioned above, and other effects that are not mentioned will be clearly understood by one skilled in the art based on appended claims.

### BRIEF DESCRIPTION OF THE DRAWINGS

FIG. 1 is a block drawing schematically illustrating the configuration of a system for managing articles according to one embodiment of the present invention.

FIG. 2 is a drawing illustrating an example of a tree structure generated by a system for managing articles according to one embodiment of the present invention.

FIG. 3 is a drawing illustrating an example in which a tree structure generated by a system for managing articles is displayed by a plurality of contents according to one embodiment of the present invention.

FIG. 4 is a flow chart illustrating a method for managing articles according to one embodiment of the present invention.

FIG. 5 is a drawing illustrating a process of a method for managing articles according to one embodiment of the present invention.

FIG. 6 is a drawing illustrating a process of inputting content in a method for managing articles according to one embodiment of the present invention.

FIG. 7 is a drawing illustrating an example of generating node information in a method for managing articles according to one embodiment of the present invention.

FIG. 8 is a drawing illustrating a tree structure generated by the system for managing articles according to one embodiment of the present invention.

FIG. 9 is a drawing illustrating an example of displaying contents of a node and a lower node selected by a user in a tree structure generated by the system for managing articles according to one embodiment of the present invention.

FIG. 10 is a drawing illustrating a state when a tree structure generated by the system for managing articles is in a first mode according to one embodiment of the present invention.

FIG. 11 is a drawing illustrating a method of displaying articles or storage places located at each level when a tree structure generated by the system for managing articles according to one embodiment of the present invention is in a first mode.

FIG. 12 is a drawing illustrating a state when the tree structure generated by the system for managing articles is changed to a second mode according to one embodiment of the present invention.

FIG. 13 is a drawing illustrating a state when a tree structure generated by the system for managing articles is in a second mode according to one embodiment of the present invention.

FIG. 14 is a drawing illustrating a state when the tree structure generated by the system for managing articles is changed to a third mode according to one embodiment of the present invention.

FIG. 15 is a view illustrating a state when the tree structure generated by the system for managing articles is in a third mode according to one embodiment of the present invention.

FIG. 16 is a drawing illustrating a state in which an article or a storage place is switched when the tree structure generated by the system for managing articles is in a third mode according to one embodiment of the present invention.

FIG. 17 is a drawing illustrating a state in which an identification mark is provided on content that is displayed when a tree structure generated by the system for managing articles is in a third mode, according to one embodiment of the present invention.

FIG. 18 is a drawing illustrating a tree structure generated by a system for managing articles and node information of each node according to one embodiment of the present invention.

FIG. 19 is a view illustrating an example of editing a tree structure generated by the system for managing articles according to one embodiment of the present invention.

FIG. 20 is a view illustrating another example of editing a tree structure generated by the system for managing articles according to one embodiment of the present invention.

FIG. 21 is a view illustrating another example of editing a tree structure generated by the system for managing articles according to one embodiment of the present invention.

FIG. 22 is a drawing illustrating a state in which a symbol tag is inserted into content displayed in a tree structure of a system for managing articles according to one embodiment of the present invention.

FIG. 23 is a drawing illustrating an example of editing contents displayed in a tree structure of a system for managing articles by using a symbol tag according to one embodiment of the present invention.

FIG. 24 is a drawing illustrating another example of editing contents displayed in a tree structure of a product management system by using a symbol tag according to one embodiment of the present invention.

FIG. 25 is a drawing illustrating another example of editing contents displayed in a tree structure of a product management system by using a symbol tag according to one embodiment of the present invention.

FIG. 26 is a drawing illustrating a state in which a notification tag is inserted into content displayed in a tree structure of a system for managing articles according to one embodiment of the present invention.

### BEST MODE FOR THE INVENTION

Hereinafter, preferred embodiments of the present invention will be described in detail in conjunction with the accompanying drawings to the extent that one skilled in the art can easily embody the present invention.

In describing the embodiments, descriptions regarding certain technologies that are well known in the technical field to which the present invention pertains and are not directly related to the present invention will be omitted. This is to convey the gist of the present invention more clearly by omitting unnecessary description.

For the same reason, some components in the accompanying drawings are exaggerated, omitted, or schematically illustrated. In addition, the size of each component does not fully reflect the actual size. The same reference number are assigned to the same or corresponding components in each figure.

Hereinafter, the present invention will be described in conjunction with the drawings for explaining a method of managing articles according to embodiments of the present invention.

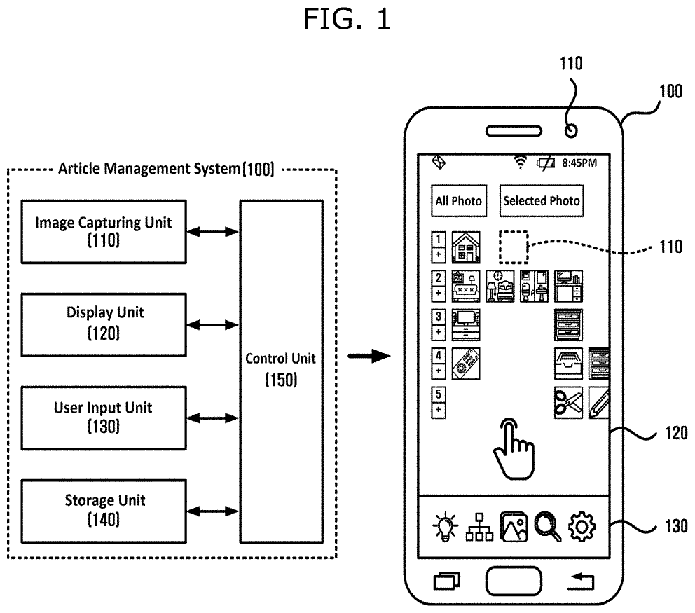

FIG. 1 is a block drawing schematically illustrating the configuration of a system for managing articles according to one embodiment of the present invention.

As shown in FIG. 1, the system for managing articles 100 according to one embodiment of the present invention may comprise an image capturing unit 110, a display unit 120, a user input unit 130, a storage unit 140, and a control unit 150.

The image capturing unit 110 may generate a photo or video by capturing an image of an article or a storage place of the article to be managed. In addition, the display unit 120 may display various types of information necessary for operating the system for managing articles 100 for a user as well as the photo or video captured by the image capturing unit 110.

In addition, the user input unit 130 may receive various commands from the user through at least one input control displayed on the user display unit 120. In this case, it is preferable that the user input unit 130 is embodied with a touch screen installed on the surface of the display unit 120 to receive intuitive and various types of commands from the user.

The storage unit 140 may store all kinds of data processed by the control unit 150 as well as applications required for operating the system for managing articles 100. The storage unit 140 is a concept including volatile memory such as RAM and non-volatile memory such as a Secure Digital Card (SD card), and various storage media capable of input/output and storage of data may be used. In addition, the storage unit 140 is mounted inside the system for managing articles 100, but may be equipped outside the system for managing articles 100 if necessary.

The control unit 150 controls the operations of the image capturing unit 110, the display unit 120, the user input unit 130, and the storage unit 140, and may exchange and process various data with the image capturing unit 110, the user input unit 130, the display unit 120, and the storage unit 140. For example, the control unit 150 may control to receive a photo or video captured by the image capturing unit 110 and store it in the storage unit 140, or may control to display a plurality of photos or videos on the display unit 120 according to a user's command input from the user input unit 130.

Preferably, as shown in FIG. 1, the system for managing articles 100 according to an embodiment of the present invention is preferably embodied using a smart phone that is portable and able to be carried with a user. In this case, the smart phone may have an application APP installed therein to perform the method for managing articles according to an embodiment of the present invention.

Meanwhile, FIG. 1 shows an example in which the system for managing articles 100 according to an embodiment of the present invention is embodied in a smart phone, but the present invention is not limited to. In other embodiments, the system for managing articles 100 may be embodied in a general computer including a personal computer (and a server that can be connected to a smart phone and a tablet PC through wired or wireless communication as well as a portable tablet PC.

Meanwhile, the system for managing articles 100 according to an embodiment of the present invention can manage content for each of the plurality of articles and the plurality of storage places with a tree structure having a hierarchy structure including a plurality of nodes.

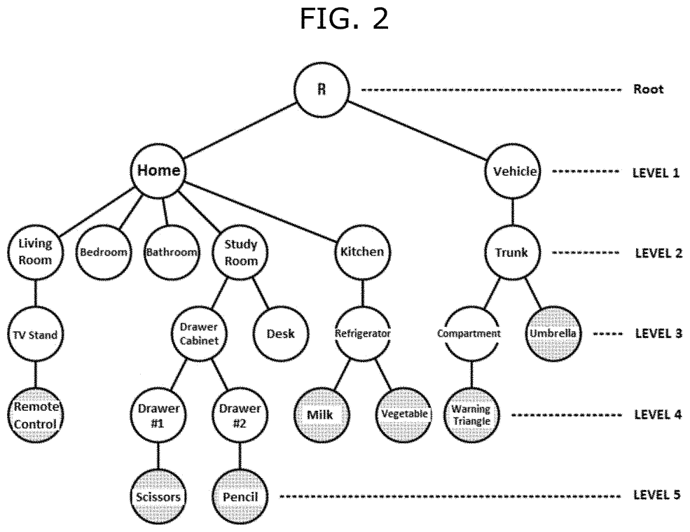

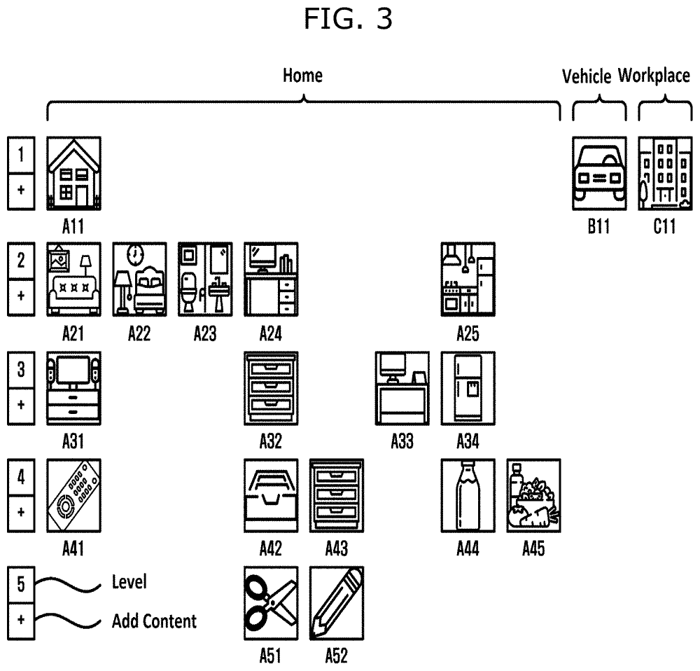

FIG. 2 is a drawing illustrating an example of a tree structure generated by a system for managing articles according to one embodiment of the present invention. FIG. 3 is a drawing illustrating an example in which a tree structure generated by a system for managing articles is displayed by a plurality of contents according to one embodiment of the present invention.

As shown in FIG. 2, the plurality of articles and the plurality of storage places may be managed in a tree structure according to their respective locations. For convenience of explanation, in FIG. 2, the articles are represented by gray nodes, and the storage places of articles are represented by white nodes. However, an article and a storage place are not needed to be clearly distinguished, and thus, for example, ‘Pencil Case’ in which ‘Pencil’ is stored may be categorized into a storage place as well as an article.

FIG. 2 shows an example of articles stored in the user's ‘Home and ‘Vehicle,’ and respective storage places. For example, the user's ‘Home’ and ‘Vehicle’ are created at Level 1 with a Root as a parent node, and ‘Living Room’, ‘Bedroom’, ‘Bathroom’, ‘Study Room’, and ‘Kitchen’, which are lower storage places that are comprised of the ‘Home’, may be created in Level 2, which is a lower level, with the ‘Home’ of Level 1 as an upper node. In addition, ‘Drawer Cabinet’ and ‘Desk’, which are lower storage places that are comprised of the ‘Study Room’, may be created in Level 3, which is a lower level, with the ‘Study Room’ of Level 2 as an upper node. Subsequent lower nodes, or child nodes, can be configured in the same way.

Accordingly, in the example of FIG. 2, when the user wants to know the storage place of ‘Scissors’, information regarding the upper nodes of the node corresponding to ‘Scissors’ can be sequentially provided to the user. Thus, the user can easily learn that the ‘Scissors’ is being stored in ‘First Drawer,’ denoted as Drawer *1, of the ‘Drawer Cabinet’ located in the ‘Study Room’ of the ‘Home’ using the tree structure.

FIG. 3 is a drawing illustrating an example in which a tree structure generated by a system for managing articles is displayed by a plurality of contents according to one embodiment of the present invention.

In the present invention, the content may use an image such as a photo or a video of an actual article or storage place captured by the image capturing unit 110 to visually represent the article or storage place.

For convenience of explanation, a photo or video representing an article and a storage place illustrated in FIG. 3 is simplified, but each photo or video may use an actual photo or video of an actual article and storage place. In addition, although FIG. 3 illustrates an example in which one photo or video is set for a specific article or a specific storage place, a plurality of photos or videos may be set for the specific product or the specific storage place, if necessary.

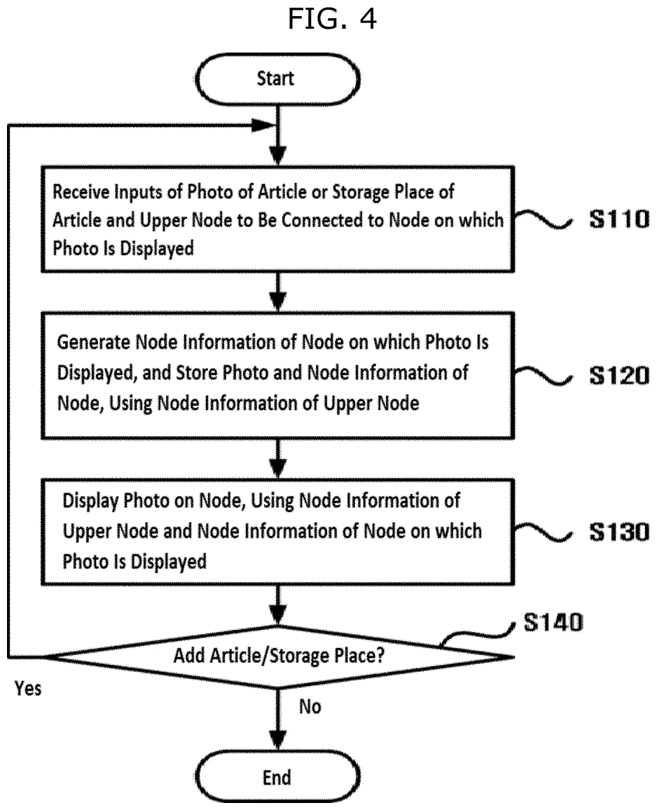

As shown in FIG. 3, when displaying articles and storage places using actual photos or videos, articles having the same name with different shapes, such as a plurality of scissors having different shapes, cab be easily distinguished from each other. In addition, the location of the article can be identified much more easily because a user can more intuitively identify the article and storage place. A detailed method of displaying a tree structure of the system for managing articles 100 according to an embodiment of the present invention using a plurality of photos or videos will be described later in detail with reference to FIGS. 4 to 17.

As described above, in case of the method for managing articles according to an embodiment of the present invention, after taking an actual photo or video of the article to be managed by the user and the storage place of the article, a plurality of pictures of the article and the storage place of the article Alternatively, by managing the video in a tree structure, it is possible to easily identify the storage place of the product, and to easily manage various types of products.

As described above, the term ‘unit’ used in the present embodiment may refer to software or hardware components such as FPGA or ASIC, and the ‘unit’ performs certain function. However, the ‘unit’ is not limited to software or hardware. The ‘unit’ may be configured to be in a location-addressed storage medium, or may be configured to reproduce one or more processors. Thus, as an example, the ‘ unit’ may refer to components such as software components, object-oriented software components, class components, and task components, processes, functions, properties, procedures, subroutines, segments of program code, drivers, firmware, microcode, circuit, data, database, data structures, tables, arrays, and variables. The components and functions provided within the ‘units’ may be combined into the smaller number of components and the ‘units’, or may be further divided into additional components and ‘units’. In addition, components and ‘units’ may be embodied to operate one or more CPUs within a device or a security multimedia card.

Hereinafter, referring to FIGS. 4 to 26, a method for managing articles using the system for managing articles 100 according to an embodiment of the present invention configured as described above will be described. In FIGS. 4 to 26, an example in which actual photos of an article and a storage place are used as contents displayed on each of a plurality of nodes for an article and a storage place will be described.

First, referring to FIGS. 4 to 7, a process of registering content for an article and a storage place using the system for managing articles 100 according to an embodiment of the present invention configured as described above will be described.

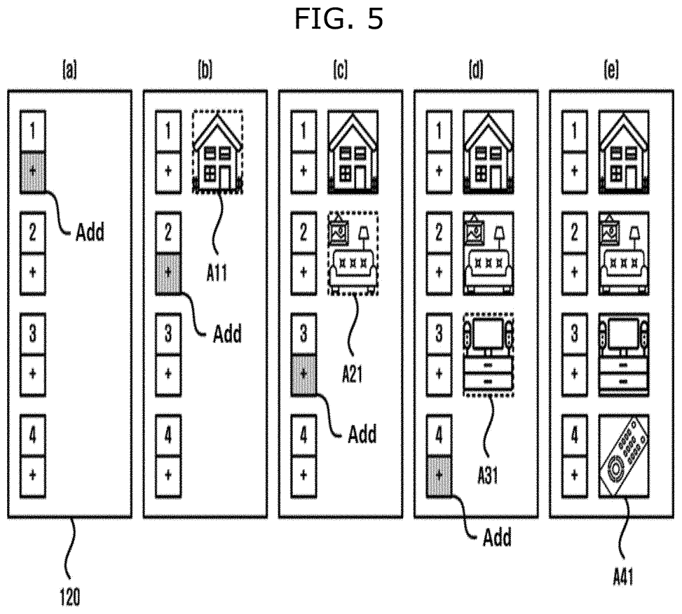

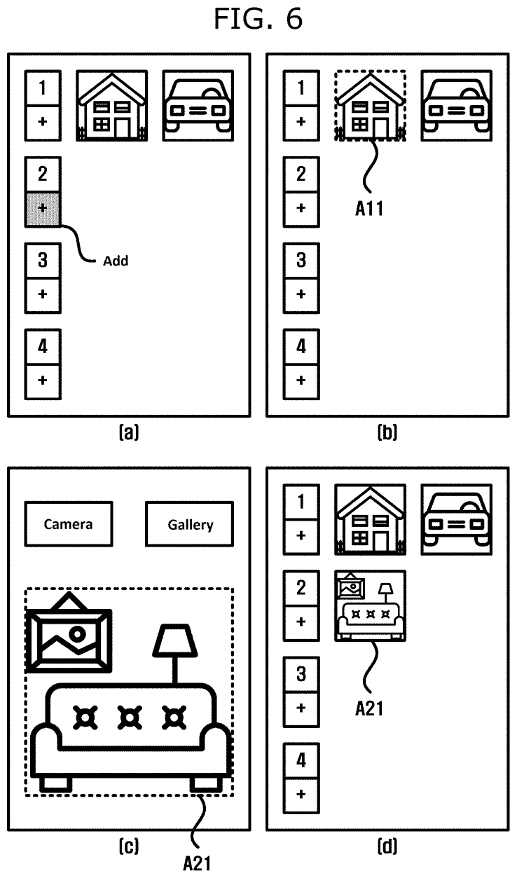

FIG. 4 is a flow chart illustrating a method for managing articles according to one embodiment of the present invention. FIG. 5 is a drawing illustrating a process of a method for managing articles according to one embodiment of the present invention. FIG. 6 is a drawing illustrating a process of inputting content in a method for managing articles according to one embodiment of the present invention.

FIGS. 5(a) to 5(e) sequentially shows an example of a process of adding a content A41 corresponding to ‘Remote Control’ shown in FIGS. 2 and 3. FIGS. 6A to 6D sequentially shows an example of a process of adding a content A21 corresponding to the ‘Living Room’, which is a lower storage place of the ‘Home’ shown in FIGS. 5(b) and 5(c).

First, as shown in FIG. 4, the user input unit 130 may receive a content for an article or a storage place of the article, and upper nodes to which a node for displaying the content is connected S110.

For example, in case of adding the content A21 for the storage place ‘Living Room’ in FIGS. 5(b) and 5(c), the user input unit 130 may be input the content A21 for the ‘Living Room’ and a content A11 for ‘Home’, which is an upper node to which the content A21 for ‘Living Room’ is connected.

Preferably, the user input unit 130 may be first selected the content displayed on an upper node to which a node on which a content for an article or storage place will be displayed is connected, and then be input a photo or video of the actual article or storage place captured by the image capturing unit 110. In other embodiments, after being captured by the image capturing unit 110, the photo or video of the actual article or storage place previously stored in the storage unit 140 may be selected to be input.

As shown in FIGS. 6(a) to 6(d), in case of adding the content A21 for the storage place ‘Living Room’, the user sequentially selects ‘Add’ button (+) shown in FIG. 6(a) and the content A11 for the ‘Home’ shown in FIG. 6(b), which is the upper node located in Level 1. Then, an input request for the ‘Living Room’ to be added may be displayed on the display unit 120, as shown in FIG. 6(c).

In this instance, when the user inputs a photo or video for the ‘Living Room’ by capturing a new photo or video using the image capturing unit 110 such as a camera, or selecting already stored in the storage unit 140 such as a gallery, as shown in FIG. 6(c), the node displaying the content A21 for the ‘Living Room’ is connected to the node that displays the content A11 for the ‘Home’ and is located at Level 1, is added at Level 2.

Referring to FIG. 4 again, after the user input unit 130 receives a content for an article or a storage place of the article and an upper node to which a node for displaying the content for the article or the storage place is connected 5110, the control unit 150 may generate node information of the node on which the content input through the user input unit 130 is to be displayed using node information of the upper node, and the storage unit 140 may store the content input through the user input unit 130 and the node information of the node on which the content input through the user input unit 130 is to be displayed 5120.

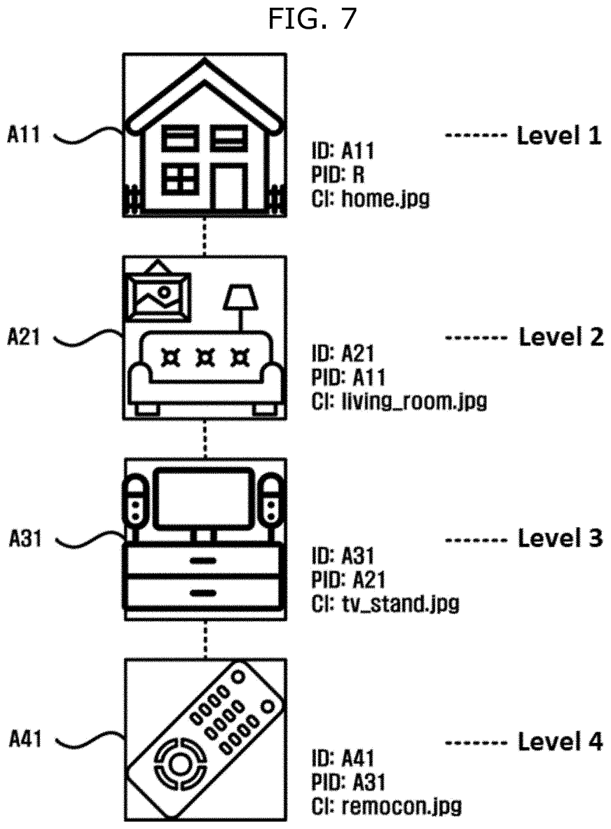

FIG. 7 is a drawing illustrating an example of generating node information in a method for managing articles according to one embodiment of the present invention.

As shown in FIG. 7, the node information of the node on which specific content is displayed may include a content identification ID, a parent node identification PID, and content information CI. FIG. 7 illustrates an example in which the content information is shown as a form of image file name, but is not limited to, and various information on the content may be further included.

For example, in case of adding the content A21 for the ‘Living Room’ to the content A11 for the ‘Home’ in FIGS. 5(b) and 5(c) of FIG. 5, the control unit 150 may generate the node information of the content A21 for the ‘Living Room’, using the node information of the content A11 for the ‘Home’, which is the upper node. In this instance, the content ID may be newly generated according to a preset rule.

Referring to FIG. 4 again, on the storage unit 140, the control unit 150 stores the content input through the user input unit 130 and the node information of the node on which the content input through the user input unit 130 is to be displayed 5120. Then, the display unit 120 displays the content on the node on which the content input through the user input unit 130 is to be displayed, using the node information of the upper node and the node information of the node on which the content input through the user input unit 130 is to be displayed S130.

As shown in FIGS. 3 and 5, the system for managing articles 100 according to an embodiment of the present invention can display in a tree structure a plurality of nodes displaying contents corresponding to each of a plurality of articles and a plurality of storage places, using node information of nodes in which the contents for each of the plurality of articles and the plurality of storage places are to be displayed.

Lastly, the control unit 150 determines whether there is an input of a content for an additional article or an additional storage place from the user S140. If there is an additional input, ‘Yes’ in step S140, steps S110 to S130 may be repeatedly performed for the additional article or the additional storage place.

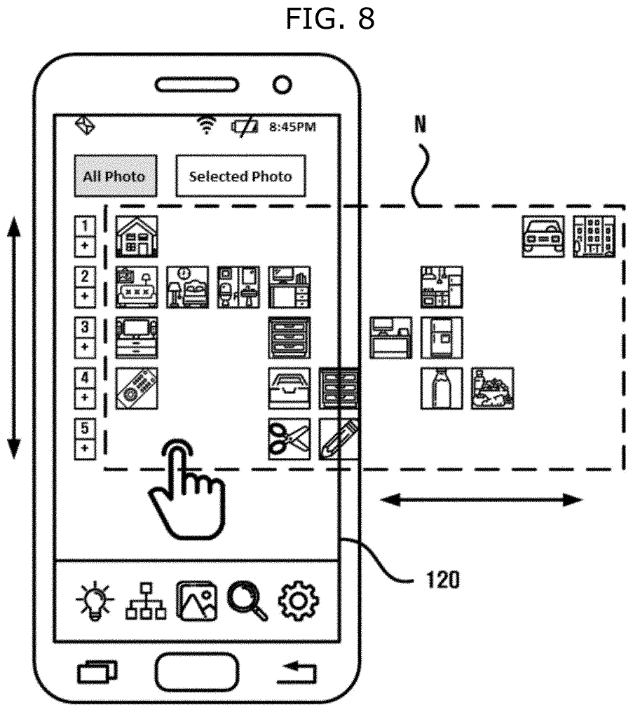

Referring to FIGS. 8 to 17, according to an embodiment of the present invention, a process for displaying a content for an article and a storage place using the system for managing articles 100 configured as described above, will be described.

FIG. 8 is a drawing illustrating a tree structure generated by the system for managing articles according to one embodiment of the present invention.

FIG. 8 shows an example in which the tree structure shown in FIG. 3 is displayed on the display unit 120 of a smart phone. The example shown in FIG. 8 is a typical tree structure displaying a plurality of contents, and is used as a screen of a basic mode, which is first displayed after registering a certain article or a certain storage place in the tree structure by the method for managing articles shown in FIG. 4.

As shown in FIG. 8, the display unit 120 may display all or part of the tree structure in which a plurality of contents are displayed based on a predetermined setting. The entire tree structure N may be scrolled in a left and right direction or in a top and bottom direction according to the user's control, and may be displayed on the display unit 120. Although not shown in detail, the entire tree structure N may be zoomed in or zoomed out according to the user's control.

Meanwhile, as shown in FIG. 8, after the plurality of nodes are displayed in the tree structure N on the display unit 120, if the user input unit 110 receives an input or selection of a content of a first node by the user, among the plurality of nodes displaying the contents for the plurality of articles and the plurality of the storage places, the display unit 120 may display the content of the first node selected by the user and the content of each of the lower nodes connected to the first node, in a emphasized form.

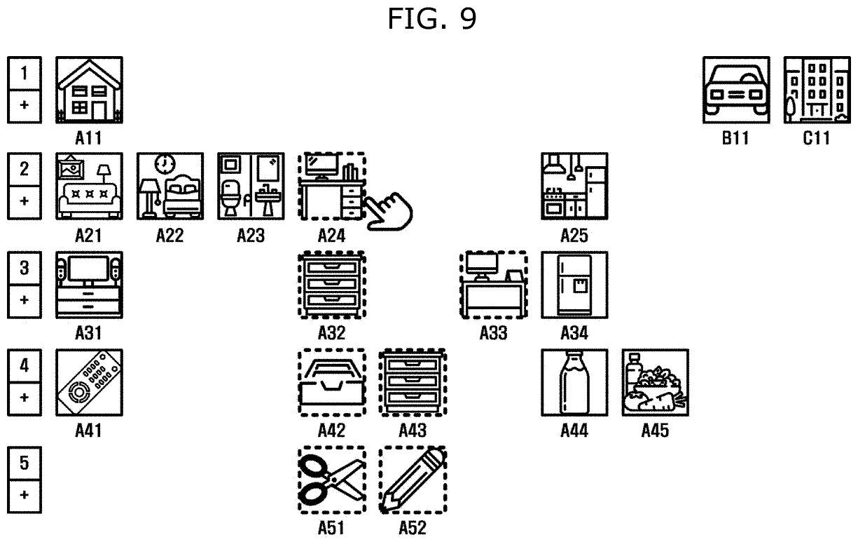

FIG. 9 is a drawing illustrating an example of displaying contents of a node and a lower node selected by a user in a tree structure generated by the system for managing articles according to one embodiment of the present invention.

FIG. 9 shows an example when content A24 for ‘Study Room’ is selected by a user in the tree structure shown in FIG. 3.

As shown in FIG. 9, when the content A24 for ‘Study Room’ is selected by the user through the user input unit 110, among a plurality of nodes displayed in a tree structure on the display unit 120, the display unit 120 may be displayed in a emphasized form, not only the contents A24 for the ‘study room’, but also the contents displayed in the lower node connected to the contents A24 for the ‘study room’, such as the contents A32 for the ‘Drawer Cabinet’, the content A33 for the ‘Desk’, the content A42 for the ‘First Drawer’ Drawer *1, a content A43 for ‘Second Drawer’ Drawer *2, the content A51 for the ‘Scissors’, and the content A52 for the ‘Pencil.’

FIG. 9 illustrates an example in which the contents displayed in a emphasized form, such as the content A24 for the ‘study room’, has a dashed line frame, but is not limited thereto.

Meanwhile, to switch to the basic mode shown in FIG. 8 from the first to the third mode, either an ‘All Photo’ button/menu displayed on the display unit 120 or a pop-up menu displayed on the display unit 120 based on the user's input can be selected.

In this way, in case of the basic mode in the method for managing articles according to an embodiment of the present invention, by displaying a plurality of photos or videos of the articles and the storage places of the articles in the tree structure, the storage place of the article can be easily identified.

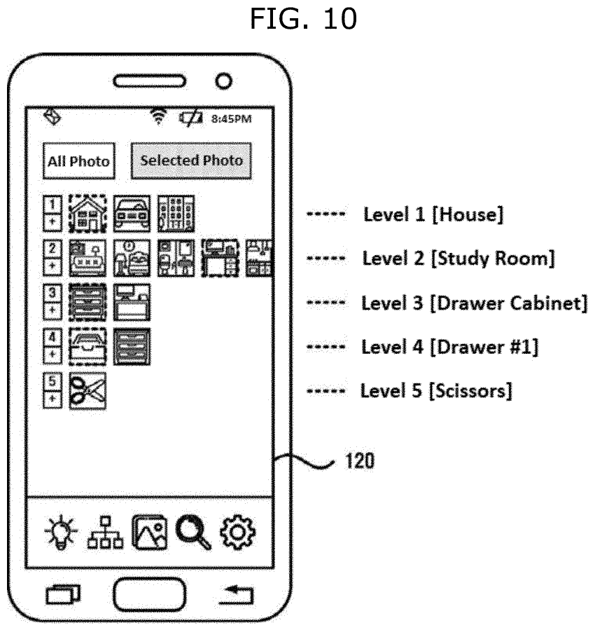

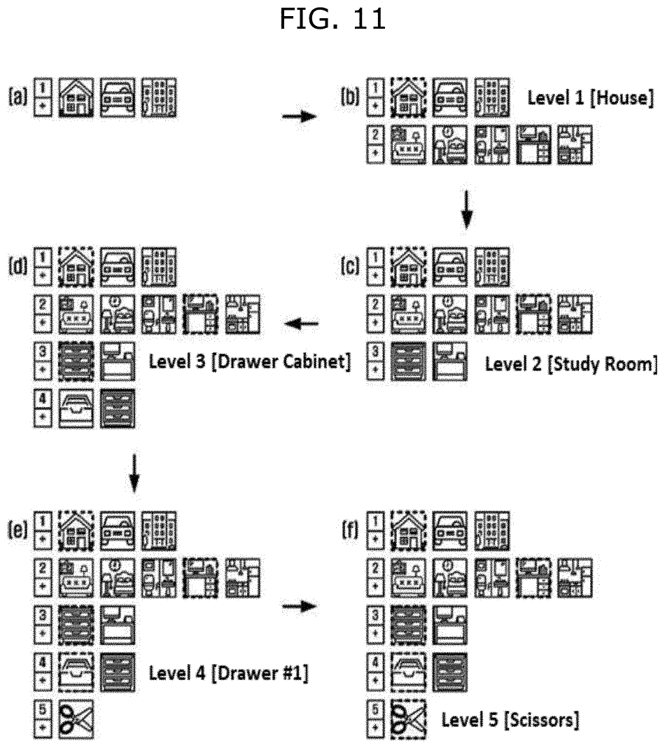

FIG. 10 is a drawing illustrating a state when a tree structure generated by the system for managing articles is in a first mode according to one embodiment of the present invention. FIG. 11 is a drawing illustrating a method of displaying articles or storage places located at each level when a tree structure generated by the system for managing articles according to one embodiment of the present invention is in a first mode.

As shown in FIG. 10, unlike the basic mode shown in FIG. 8, the first mode refers to a display mode that does not display the entire tree structure for the plurality of contents, but display only content of the lower node, which is connected to a content for a certain article or a certain storage place selected at each level. The first mode may be switched by selecting a ‘Selected Photo’ button/menu displayed on the display unit 120 or a pop-up menu displayed on the display unit 120 based on a user's input in the basic mode shown in FIG.8.

Referring to the example shown in FIGS. 3 and 8 again, FIG. 10 illustrates a display screen in the first mode, when the content A11 for the ‘Home’ located at level 1, the content A24 for the ‘Study Room’ located at level 2, the content A32 for the ‘Drawer Cabinet’ located at level 3, the content A42 for the ‘First Drawer’ Drawer *1 at level 4, and the content A51 for the ‘Scissors’ at level 5 are sequentially selected.

First, as shown in FIG. 11(a), when switching from the basic mode shown in FIG. 8 to the first mode, the contents of nodes located at the first level such as content A11, B11, C11 for the ‘Home’, the ‘Vehicle’, and ‘Workplace’, which are in the highest level, among the plurality of nodes in the tree structure, may be first displayed.

Thereafter, contents of lower nodes connected to a node selected by a user among the nodes located at a specific level may be sequentially displayed.

Specifically, as shown in FIG. 11(b), when the user selects the content A11 for the ‘Home’ located at the first level, only the contents A21, A22, A23, A24, A25 for the ‘Living Room’, the ‘Bedroom’, the ‘Bathroom’, the ‘Study Room’, and the ‘Kitchen’, which are lower nodes of the node on which the content A11 for the ‘Home’, are displayed, among the plurality of nodes located at the second level, and contents displayed in lower nodes of nodes on which contents B11 and C11 for the ‘Vehicle’ and the ‘Workplace’ may be converted to a hidden state.

In addition, as shown in FIG. 11(c), when the user selects the content A24 for the ‘Study Room’ located at the second level, only the contents A32, A33 for the ‘Drawer Cabinet’ and the ‘Desk’, which are the lower nodes of the node on which the content A24 is displayed, are displayed, among the plurality of nodes located at the third level. Furthermore, as shown in FIG. 11(d), when the user selects the content A32 for the ‘Drawer Cabinet’, only contents A42, A43 for the ‘First Drawer’ Drawer *1 and the ‘Second Drawer’ Drawer *2 located at the fourth level are displayed. Likewise, as shown in FIG. 11(e), when the user selects the content A42 for the ‘First Drawer’ Drawer *1 located at the fourth level, only the content A51 for the ‘Scissors’ located at the fifth level can be displayed.

However, as shown in FIG. 11(f), when the user selects the content A51 for the ‘Scissors’ located at the fifth level, which is the lowest level, there may be no change in the screen because there is no further connected lower node.

As described above, in case of the first mode in the method for managing articles according to an embodiment of the present invention, articles placed in a certain storage place can be easily searched.

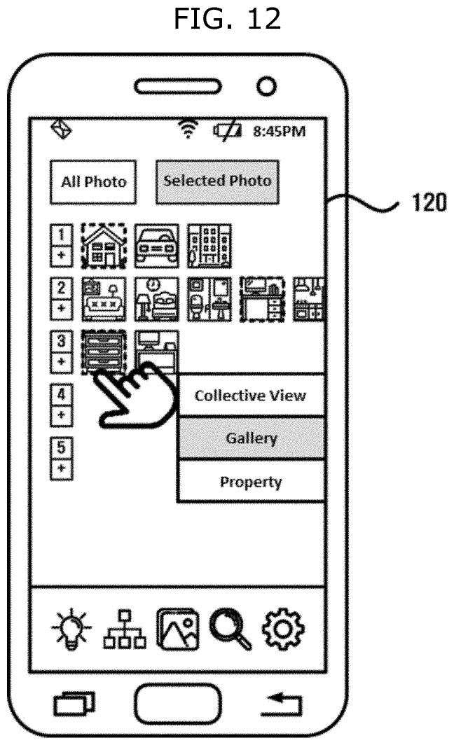

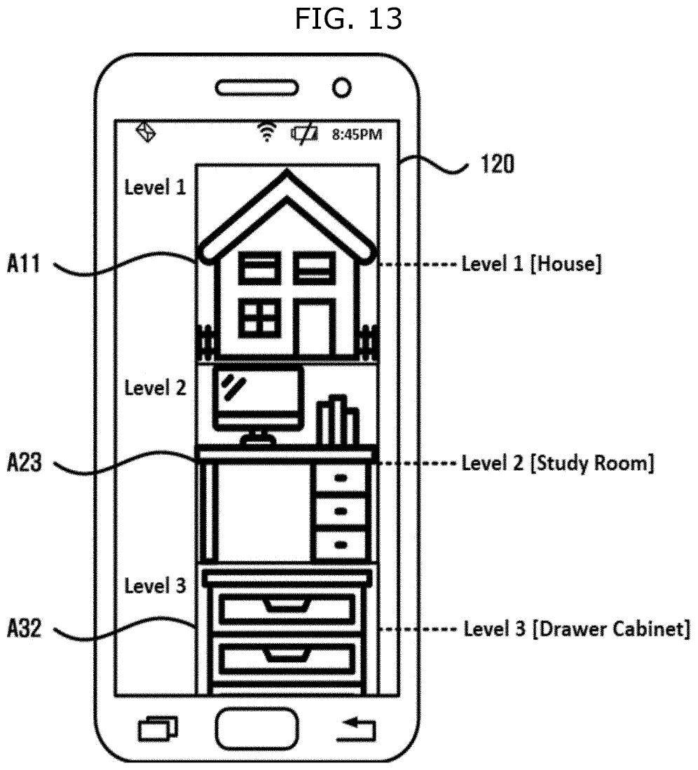

FIG. 12 is a drawing illustrating a state when the tree structure generated by the system for managing articles is changed to a second mode according to one embodiment of the present invention. FIG. 13 is a drawing illustrating a state when a tree structure generated by the system for managing articles is in a second mode according to one embodiment of the present invention.

The second mode refers to a display mode that displays only contents of higher nodes connected to a content for a specific article or a specific storage place selected at each level.

As shown in FIG. 12, the second mode may be appeared by using a pop-up menu of a content for a specific article or a specific storage place displayed on a node selected by a user in the basic mode shown in FIG. 8 or the first mode shown in FIG. 10. FIG. 12 illustrates an example of switching to the second mode by selecting the ‘Collective View’ menu from the pop-up menu of the content A32 for the ‘Drawer Cabinet’ located at the third level.

In addition, as shown in FIG. 13, in the second mode, contents in upper nodes connected to a node displaying the content A32 for the ‘Drawer Cabinet’ selected by the user, are displayed. Thus, the content A11 for the ‘Home’ located at the first level and the content A24 for the ‘Study Room’ located at the second level may be displayed in order of level.

As described above, in case of the second mode in the method for managing articles according to an embodiment of the present invention, a location of a specific article or a specific storage place can be easily searched.

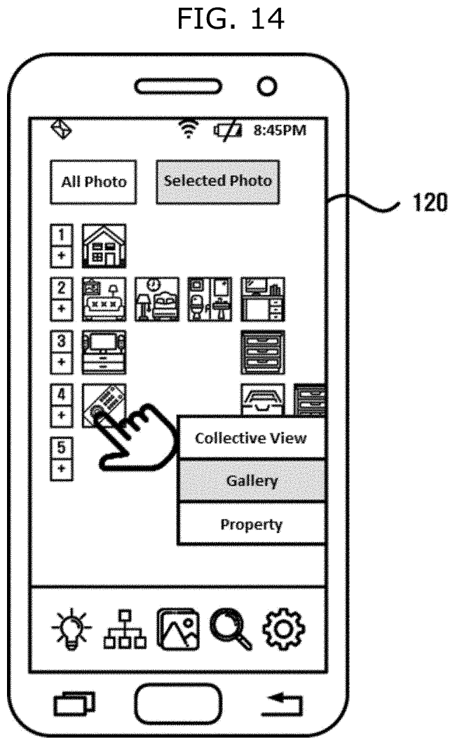

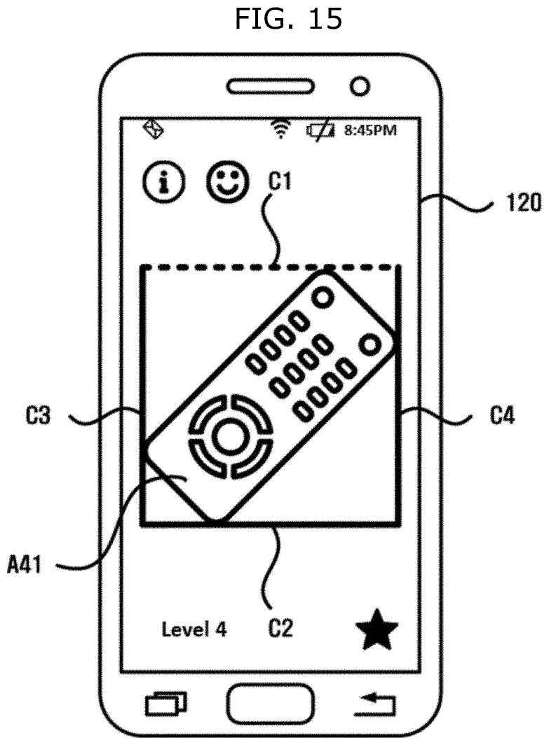

FIG. 14 is a drawing illustrating a state when the tree structure generated by the system for managing articles is changed to a third mode according to one embodiment of the present invention. FIG. 15 is a view illustrating a state when the tree structure generated by the system for managing articles is in a third mode according to one embodiment of the present invention.

The third mode refers to a display mode in which a content for a specific article or a specific storage place selected at each level is displayed on the full screen.

As shown in FIG. 14, the third mode may be appeared by using a pop-up menu of content for a specific article or a specific storage place displayed on a node selected by a user in the basic mode shown in FIG. 8 or the first mode shown in FIG. 10. FIG. 14 shows an example of switching to the third mode by selecting ‘Gallery’ menu in a pop-up menu of the content A41 for the ‘Remote Control’ located at a fourth level in the basic mode shown in FIG. 8.

As shown in FIG. 15, in the third mode, only the content A41 for the ‘Remote Control’ selected by the user may be displayed on the full screen. FIG. 15 shows an example in which other information, such as level information, properties, and favorites, is displayed in addition to the content A41 for the ‘Remote Control’, but is not limited to. The screen of the third mode can be changed to include various information by one skilled in the art.

Meanwhile, in the third mode, the screen on the display unit 120 may be switched by a user's control to display other content in a node adjacent to the current content for a specific article or a specific storage place currently displayed on the full screen of the display unit 120.

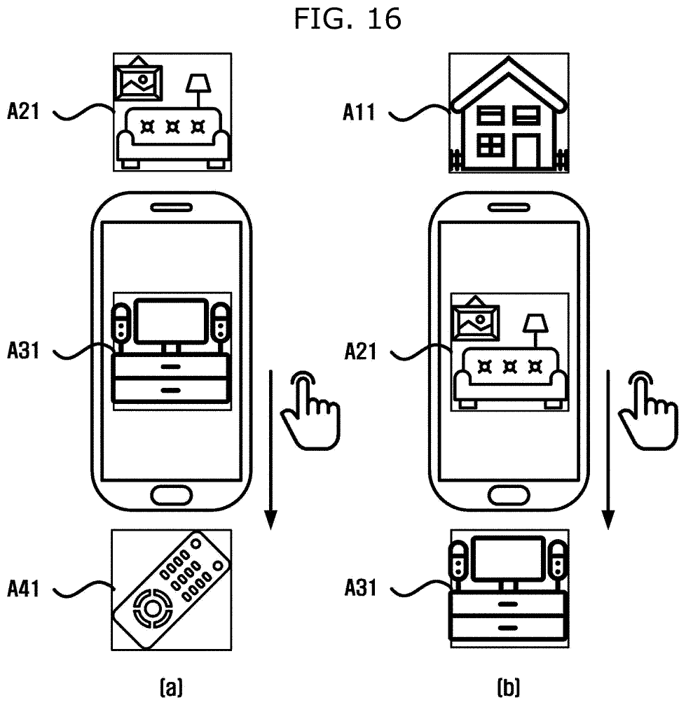

FIG. 16 is a drawing illustrating a state in which an article or a storage place is switched when the tree structure generated by the system for managing articles is in a third mode according to one embodiment of the present invention.

FIG. 16(a) shows an example of switching to a content A31 for ‘TV Stand’ in a node, which is adjacent to the node of the content A41 for the ‘Remote Control’ shown in FIG. 15, and displaying the content A31 in the full screen, based on the user's input. FIG. 16(b) shows an example of switching to the content A21 for the ‘Living Room’ in the node, which is adjacent to the node of the content A31 for the ‘TV Stand’, and displaying the content A21 in the full screen, based on the user's input.

FIGS. 16(a) and 16(b) show examples of switching to the content displayed on the nodes at different levels by vertically scrolling in the top and bottom direction, is not limited to. The screen can be switched between contents displayed on adjacent nodes at the same level by horizontally scrolling in the left and right directions.

Meanwhile, referring to FIG. 15 again, the third mode may include identification marks Cl to C4 indicating whether a content on a node adjacent to the content of a specific article or a specific storage place displayed on the full screen, exists or not.

Thus, as shown in FIG. 15, the identification marks C1 to C4 indicating the presence of content that can be switched in the vertical and horizontal directions, may be provided on the top, the bottom, the left, and the right of the content displayed on the full screen.

Referring to the example of FIG. 14 together, FIG. 15 shows identification marks Cl to C4 representing whether a content on a node, which is adjacent to the content A41 for the ‘Remote Control’, exists or not, on the top, the bottom, the left, and the right of the content A41 located at level 4.

As shown in FIG. 14, since only the content A31 for the ‘TV Stand’ at the level 3 exists adjacent to the content A41 for the ‘Remote Control’ located at the Level 4 in the upper direction, as shown in FIG. 15, an identification mark Cl shown in a dashed line, which indicates the existence of the content on an adjacent node, is provided on the top of the content A41 for the ‘Remote Control.’ In this instance, identification marks C2 to C4 shown in a solid line, which indicate no content on the adjacent node, is provided on the bottom, the right, and the left of the content A41.

In FIG. 15, as an example of identification marks Cl to C4 indicating whether a content of an adjacent node exists or not, a solid line and a dashed line) are described, but each of the identification marks Cl to C4 may be embodied with different color or different symbols.

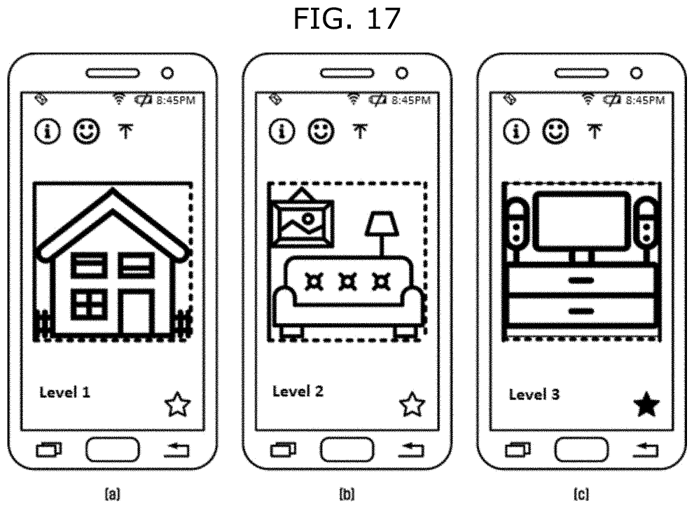

FIG. 17 is a drawing illustrating a state in which an identification mark is provided on a content when a tree structure generated by the system for managing articles is in a third mode, according to one embodiment of the present invention.

Referring to FIGS. 17(a) to 17(c), FIG. 17(a) shows that the content A11 for the ‘Home’ has contents on switchable nodes, which exist in the right direction at the same level and the bottom direction at the lower level of the content A11 for ‘Home’, respectively. FIG. 17(a) shows that the content A21 for the ‘Living Room’ has contents on switchable nodes, which exist in the top direction at the upper level, in the right direction at the same level, and in the bottom direction at the lower level, respectively. FIG. 17(c) shows that the content A31 for the ‘TV Stand’ has contents on switchable nodes, which exist witched in the top direction at the upper level and in the bottom direction at the lower level, respectively.

As described above, in case of the third mode in the method for managing articles according to an embodiment of the present invention, articles or storage places adjacent to a specific article or a specific storage place can be more easily searched.

In other words, in case of the method for managing articles according to an embodiment of the present invention, by displaying a plurality of contents for articles and the storage places of the articles in various display modes, the article can be more easily searched under various conditions.

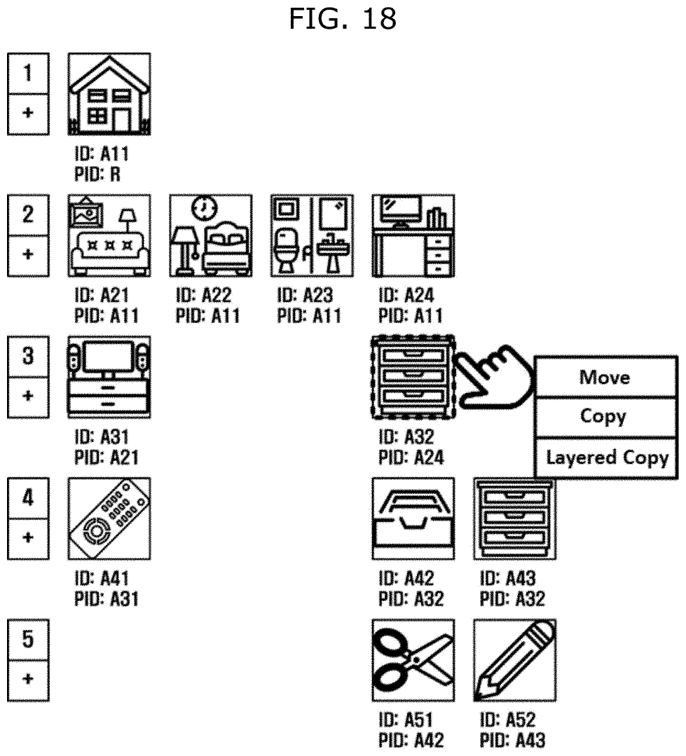

Next, with reference to FIGS. 18 to 26, a process of editing contents for an article and a storage place using the system for managing articles 100 configured as described above according to an embodiment of the present invention will be described.

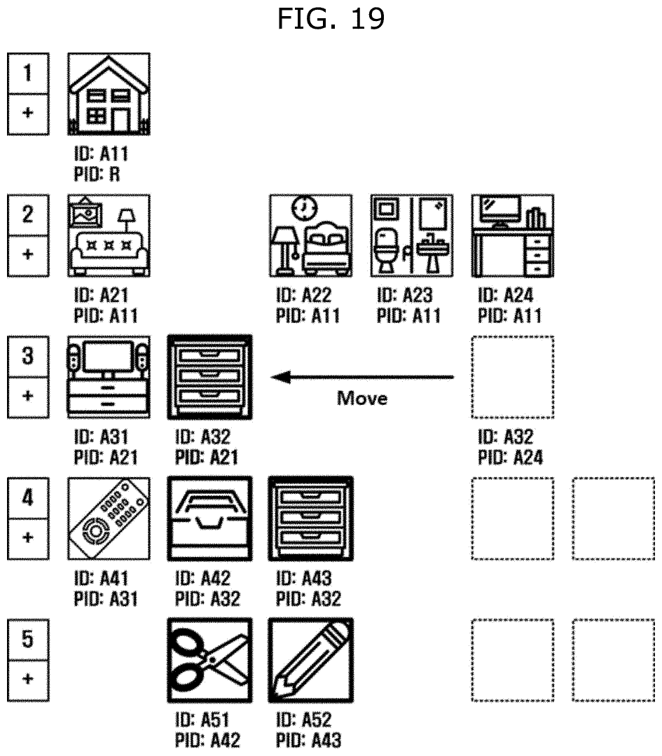

FIG. 18 is a drawing illustrating a tree structure generated by a system for managing articles and node information of each node according to one embodiment of the present invention. FIG. 19 is a view illustrating an example of editing a tree structure generated by the system for managing articles according to one embodiment of the present invention.

Referring to the example shown in FIG. 3 together, FIGS. 18 and 19 shows an example of moving the ‘Drawer Cabinet’ located in the ‘Study Room’ into the ‘Living Room’. The example shows a process of moving the upper node of the content A32 for the ‘Drawer Cabinet’ connected to the content A24 for the ‘Study Room’ to the content A21 for the' Living Room'.

As shown in FIGS. 18 and 19, the user input unit 130 may change the upper node of the corresponding node by sequentially receiving inputs of the node of the content A32 for the ‘Drawer Cabinet’ and the node of the content A21 for the ‘Living Room’. In this case, the node of the content A21 for the ‘Living Room’ is the upper node to which the node for the content A43 is newly connected.

In addition, the control unit 150 can change and store the parent node identification PID in node information of a node on which the content A32 for the ‘Drawer Cabinet’ is displayed, using a content identification ID, which is node information of a node on which the content A21 for the ‘Living Room’ is displayed.

Lastly, the display unit 120 displays a plurality of contents in a tree structure, using node information of a node on which the content A21 for the ‘Living Room’ is displayed and node information of a node on which content A32 for the ‘Drawer Cabinet’ is displayed.

In this case, as shown in FIG. 19, when the upper node of the node on which the content A32 for the ‘Drawer Cabinet’ is displayed is moved, the contents of the lower nodes connected to the content A32 for the ‘Drawer Cabinet’, such as the contents A42, A43 for the first drawer, Drawer *1, and the second drawer, Drawer *2, and the contents A51, A52 for the ‘Scissors’ and ‘Pencils’ stored therein, are also moved.

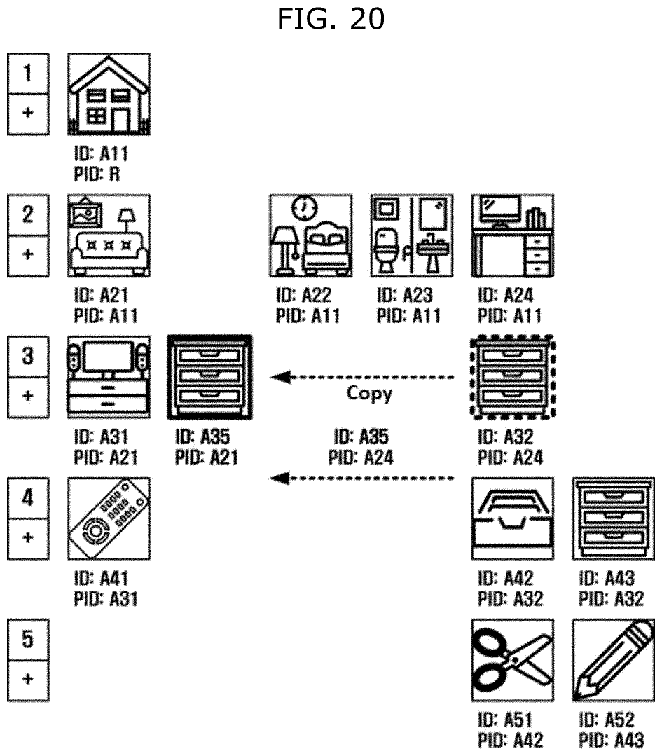

FIG. 20 is a view illustrating another example of editing a tree structure generated by the system for managing articles according to one embodiment of the present invention.

Referring to the example shown in FIG. 3 together, FIGS. 18 and 20 shows an example of copying the ‘Drawer Cabinet’ located in the ‘Study Room’ to the ‘Living Room’. Specifically, the example shows of process of copying the content A32 for the ‘Drawer Cabinet’ connected to the content A24 for the ‘study room’, creating a new node, second rode, on. which the content A32 for the ‘Drawer Cabinet’ is displayed, and switching the upper node of the second node to the content A21 for ‘Living Room’.

As shown in FIGS. 18 and 20, when the user input unit 130 sequentially receives inputs of the node of the content A32 for the ‘Drawer Cabinet’ and the node of the content A21 for the ‘Living Room’, the control unit 150 can create the second node having content identification ID of ‘A35’ and parent node identification PID of ‘A21’ by copying the node on which the content A32 for the ‘Drawer Cabinet’ is displayed. In this case, the node of the content A21 for the ‘Living Room is a higher node to which the node for the content A35 is newly connected.

In addition, as shown in FIG. 20, the control unit 150 changes the parent node identification PID of the second node to ‘A21’by using the content identification ID of the node on which the content A21 for the ‘Living Room’ is displayed. The change of the parent node identification PID may be stored in the storage unit 140.

Lastly, the display unit 120 displays a plurality of contents in a tree structure, using node information of a node on which the content A21 for the ‘Living Room’ is displayed and node information of a node on which the content A32 for the ‘Drawer Cabinet’ is displayed. In this case, as shown in FIG. 20, when the upper node of the node on which the content A32 for the ‘Drawer Cabinet’ is displayed is moved, the contents of the lower nodes connected to the content A32 for the ‘Drawer Cabinet’ may not be moved and stay at their original locations.

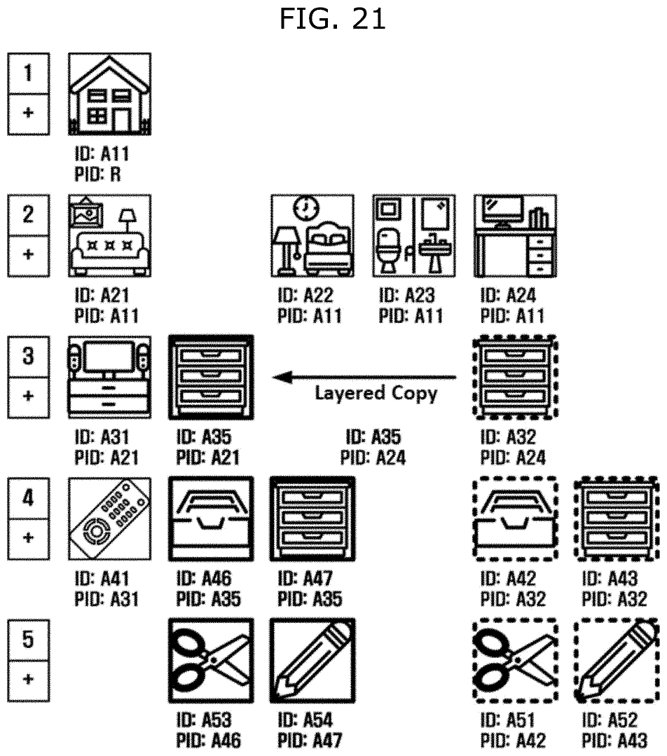

FIG. 21 is a view illustrating another example of editing a tree structure generated by the system for managing articles according to one embodiment of the present invention.

Referring to the example shown in FIG. 3 together, FIGS. 18 and 21 shows an example of copying the ‘Drawer Cabinet’ located in the ‘Study Room’ to the ‘Living Room’ along with other articles stored in the ‘Drawer Cabinet’. In the present invention, this function will be referred to as ‘Layered Copy.’ Specifically, the example shows of a process of copying a first node of the content A32 for the ‘Drawer Cabinet’ connected to the content A24 for the ‘study room’, creating a new node, a second node, on which the content A32 for the ‘Drawer Cabinet’ is displayed, and switching the upper node of the second. node to the content A21 far ‘Living Room’.

As shown in FIGS. 18 and 20, when the use input unit 130 sequentially receives inputs of the node of the content A32 for the ‘Drawer Cabinet’ and the node of the content A21 for the ‘Living Room’, the control unit 150 can create the second node having content identification ID of ‘A35’ and parent node identification PID of ‘A21’ by copying the node on which the content A32 for the ‘Drawer Cabinet’ is displayed. In this case, the node of the content A21 for the ‘Living Room is a higher node to which the node or the content A35 is newly connected. In this case, as shown in FIG. 20, the control unit 150 changes the parent node identification PID of the second node to ‘A21’ by using the content identification ID of the node on which the content A21 for the ‘Living Room’ is displayed. The change of the parent node identification PID may be stored in the storage unit 140.

In addition, since there are the lower nodes connected. to the first node of the content A32 for the ‘Drawer Cabinet’, the control unit 150 can newly create third nodes having content identification IDs of ‘A46’, ‘A47’, ‘A53’, ‘A54’ by respectively copying the contents A42, A43, A51, A52 for the ‘First Drawer’ Drawer #1, the ‘Second Drawer’ Drawer #2, the ‘Scissors’, and the ‘Pencil’, which are connected to the first node of the content A32 for the ‘Drawer Cabinet’. Then, as shown in FIG. 21, the control unit 150 changes parent node identification PTDs to ‘A35’, ‘A35, ‘A46’, ‘A47’, by asking the content identification ID of the newly created second and third node.

Lastly, the display unit 120 displays a plurality of contents in a tree structure, using node information of a node on which the content A21 for the ‘Living Room’ is displayed, node information of a node on which the content A32 for the ‘Drawer Cabinet’ is displayed, and node information of nodes in which the contents A42, A43, A51, A52 for the ‘First Drawer’ Drawer #1, the ‘Second Drawer’ Drawer #2, the ‘Scissors’, and the ‘Pencil’ are displayed.

In this case, as shown in FIG. 21, when the node of the content A32 for the ‘Drawer Cabinet’ is display is layered-copied, the contents of the lower nodes connected to the content A32 for the ‘Drawer Cabinet’, such as the contents A42, A43 for the first drawer, Drawer #1, and the second drawer, Drawer #2, and the contents A51, A52 for the ‘Scissors’ and ‘Pencils’ stored therein, are also copied.

As described above, according to a method for managing article according to one embodiment of the present invention, a part of a plurality of photos or videos of the article and the storage places of the article can be moved, copied, and deleted in a layered unit of a tree structure, thereby allowing a user to add and manage the articles more easily.

In other words, since a part of a plurality of photos or videos of the article and the storage places can be moved, copied, and deleted in a layered unit of a tree structure, situations such as moving or changing furniture arrangement do not require a process of creating a new photo or video for the articles and storage places, and this process can be omitted. Accordingly, a process of registering the photo or video can be more easily performed.

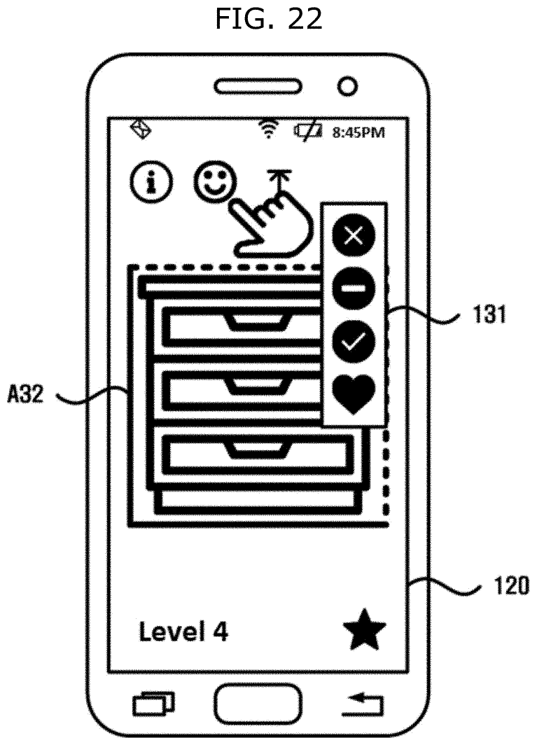

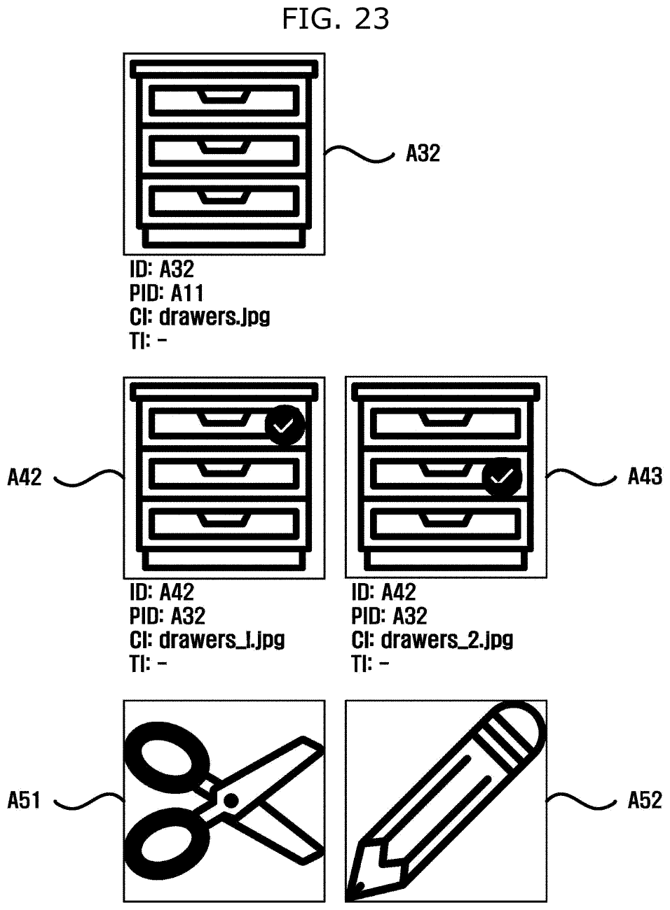

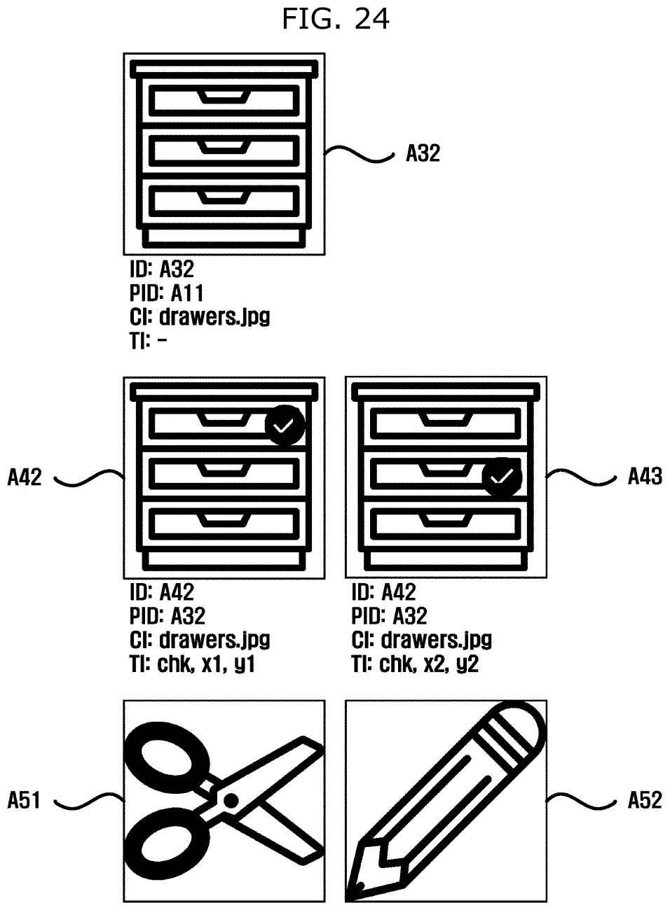

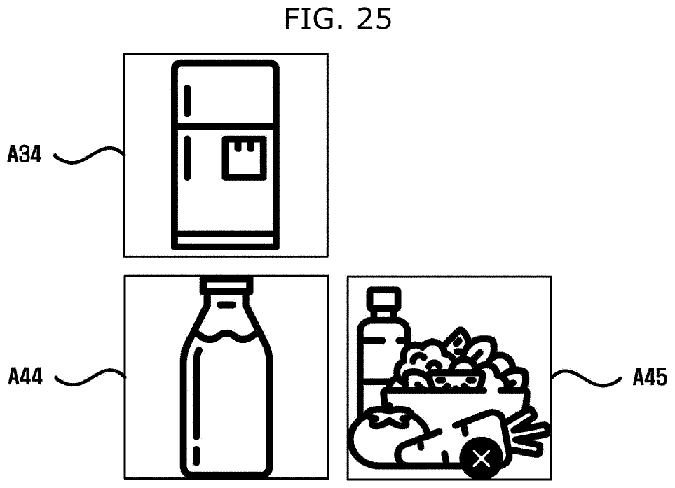

FIG. 22 is a drawing illustrating a state in which a symbol tag is inserted into content displayed in a tree structure of a system for managing articles according to one embodiment of the present invention. FIG. 23 is a drawing illustrating an example of editing contents displayed in a tree structure of a system for managing articles by using a symbol tag according to one embodiment of the present invention. FIG. 24 is a drawing illustrating another example of editing contents displayed in a tree structure of a product management system by using a symbol tag according to one embodiment of the present invention. FIG. 25 is a drawing illustrating another example of editing contents displayed in a tree structure of a product management system by using a symbol tag according to one embodiment of the present invention.

The symbol tag 131 is inserted into the content of the node selected by the user to indicate the state of the content, and may be composed of symbols of various shapes. As shown in FIGS. 15 and 22, the symbol tag 131 can be inserted in a third mode in which content for a specific article or a specific storage place is displayed in full screen, and is photographed by the image capture unit 110 It is inserted into the content previously stored in the storage unit 140 to edit the content.

First, FIG. 23 shows an example of editing a content by inserting a symbol tag 131. The example shows a process of creating a new content by inserting the symbol tag 131 into a content previously stored in the storage unit 140.

As shown in FIGS. 22 and 23, after creating the content A32 for the ‘Drawer Cabinet’, the contents A42, A43 for the ‘First Drawer’ Drawer *1 and the ‘Second Drawer’ Drawer *2 to be displayed in the lower nodes of the node on which the content A32 for the ‘Drawer Cabinet’ is displayed, are not newly photographed by the image capturing unit 110, but can be created by inserting the symbol tag 131 thereto.

In other words, as shown in FIG. 23, a symbol tag 131 in the form of ‘Check Mark’ can be inserted into the content A32 for the ‘Drawer Cabinet’ at the position of the first drawer and the position of the second drawer, and accordingly, a content A42 for ‘First Drawer’ Drawer *1 and a content A43 for the ‘Second Drawer’ Drawer #2 can be newly created.

In this case, the content A42 for ‘First Drawer’ Drawer #1 and content A43 for the ‘Second Drawer’ Drawer #2 may be created by combining the symbol tags 131 in the form of ‘Check Mark’ to the content A32 for the ‘Drawer Cabinet’, respectively. For example, as shown in FIG. 23, a content A42 for ‘First Drawer’ Drawer #1 may be created as a new image ‘drawers_1.jpg’, by inserting the symbol tag 131 in the form of ‘Check Mark’ to an image ‘drawers.jpg’ of the content A32 for the ‘Drawer Cabinet’.

FIG. 24 shows another example of editing a content by inserting the symbol tag 131. According to this example, a content A42 for ‘First Drawer’ Drawer #1 and a content A43 for the ‘Second Drawer’ Drawer #2 may be newly created by using tag information of the content A32 for the ‘Drawer Cabinet’, respectively.

As shown in FIG. 24, the node information of the node on which a certain content is displayed, may include tag information TI in addition to content identification ID, parent node identification PDI, and content information CI.

In this case, the content A42 for ‘First Drawer’ Drawer #1 and content A43 for the ‘Second Drawer’ Drawer #2 may be respectively created by combining tag information of the symbol tags 131 in the form of ‘Check Mark’ to the content A32 for the ‘Drawer Cabinet’.

For example, as shown in FIG. 24, a content A42 for ‘First Drawer’ Drawer #1 may be created by using an image ‘drawers.jpg’ of the content A32 for the ‘Drawer Cabinet’ and tag information TI of the symbol tag 131 inserted into the image ‘drawers.jpg’. In this case, the tag information TI includes the type, such as ‘Check Mark’ chk, and the position, such as coordinates x1, y1, of the symbol tag 131.

In other words, in the example shown in FIG. 24, the new image ‘drawers 1.jpg’ of the content A42 for the ‘First Drawer’ Drawer #1, which is shown in the example of FIG. 23, is not newly created. Since the existing image ‘drawers.jpg’ of the content A32 for the ‘Drawer Cabinet’ is used as it is, not only can the capacity of the contents stored in the storage unit 140 be reduced, but also various contents using the tag information TI of the symbol tag 131 can be created. Therefore, contents can be easily added, edited, and deleted.

As described above, since a new image or video can be created by inserting a symbol tag 131 to an existing photo or video, a process for newly capturing a photo or video using the image capturing unit 110, can be omitted. Accordingly, a process of registering the photo or video can be more easily performed.

Meanwhile, FIG. 23 shows another example of editing a content by inserting a symbol tag 131. The example shows a process of reflecting changes in a part of articles included in a content, which is previously stored in the storage unit 140, by inserting the symbol tag 131 into the content.

FIG. 25 shows an example in which the content A44 for ‘Milk’ and the content A45 for ‘Vegetables’ such as lettuce and carrots are displayed in lower nodes of the node on which the content A34 for ‘Refrigerator’ is displayed.

If the carrots are consumed or discarded from among the lettuces and carrots included in the content for ‘Vegetables’ A45, the image capturing unit 110 does not take a new photo of the lettuce, excluding the carrots, but the content A45 for the ‘Vegetable’ can be updated to the latest state by inserting a symbol tag 131 in the form of ‘Delete Mark’ at the position corresponding to the carrots in the content A45 for the carrots.

Meanwhile, although not shown, in case of a new carrots, the symbol tag 131 in the form of the ‘Delete Mark’ inserted in the content A45 for the ‘Vegetables’ may be deleted, and thus, the content A45 for the ‘Vegetable’ can also be updated to the latest state.

As described above, since the state of the existing image or video can be changed by inserting a symbol tag 131, thereby omitting a process for capturing a new photo or video using the image capturing unit 110, a process of registering the photo or video can be more easily performed.

Thus, according to a method for managing article according to one embodiment of the present invention, by inserting a symbol tag into an article and setting a certain property on the article, a user can more easily perform the processes of adding and managing the articles.

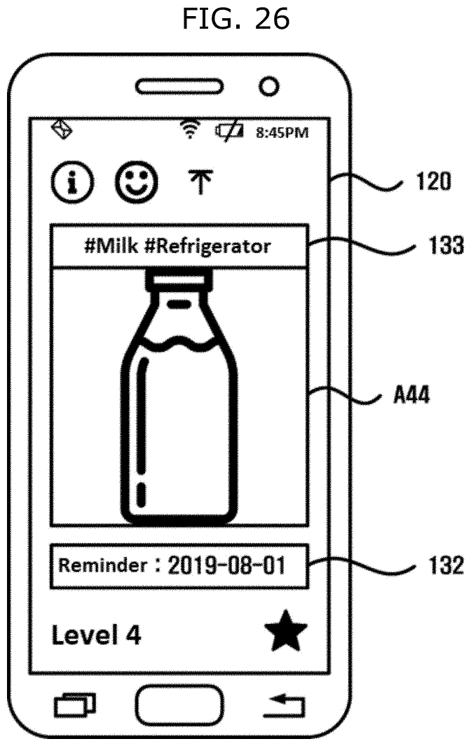

FIG. 26 is a drawing illustrating a state in which a notification tag is inserted into content displayed in a tree structure of a system for managing articles according to one embodiment of the present invention.

The notification tag 132 is inserted into the content of a node by a user to perform reminder function for the content, and may be set in the various form such as a notification time and a timer for the content.

As shown in FIGS. 15 and 26, the notification tag 132 may be set in the third mode in which the content for a specific item or a specific storage place is displayed in the full screen. Referring to in the example of FIG. 25 together, FIG. 26 shows an example in which a notification tag 132 for notifying the expiration date of ‘Milk’ of the content A44, which is displayed on the lower node of the node of the content A34 for the ‘Refrigerator’, is set.

Meanwhile, as shown in FIG. 26, a hash tag #133 for assisting search function may be set in the content for a specific article or a specific storage place.

As described above, according to a method for managing article according to one embodiment of the present invention, by inserting a notification tag into an article and setting a reminder function for the article, a user can more easily perform the processes of adding and managing the articles.

The present specification and drawings disclose preferred embodiments of the present invention. Although specific terms are used, these are merely used in a general meaning to easily explain the technical idea of the present invention and to assist understanding of the present invention, and is not intended to limit the scope of the present invention. It is obvious to one skilled in the art that other modifications based on the technical idea of the present invention may be implemented in addition to the embodiments disclosed herein.

The present invention relates to a product management method, and more particularly, it is applicable to the technical field related to a product management method capable of easily managing various types of articles as well as easily identifying a storage place of the product.

### INDUSTRIAL APPLICABILITY

The present invention relates to a method for managing articles, and more specifically, to a method for managing articles capable of easily identifying storage places of articles and managing various kinds of articles. Accordingly, the present invention can be applicable to technical fields related to a method of managing articles.

What is claimed is:

1. A method for managing articles using a system for managing articles that includes an image capturing unit, a display unit, a user input unit, a storage unit, and a control unit controlling the image capturing unit, the display unit, the user input unit, and the storage unit, and that manages a plurality of storage places and a plurality of the articles located at the plurality of the storage places, respectively, the method comprising:
a step A-1 of receiving an input, by the user input unit from a user, of selecting a photo or video displayed on an upper node to which a node on which a photo or video of an article or a storage place of the article is to be displayed, is to be connected as a lower node;
a step A-2 of receiving an input, by the user input unit, of an actual photo or video of the article or the storage place that is captured by the image capturing unit, or that was previously captured using the image capturing unit and stored in the storage unit;
a step B of:
generating node information, by the control unit, of the node on which the photo or video input through the user input unit, is to be displayed, using node information of the upper node, and
storing, by the storage unit, the photo or video input through the user input unit and the node information of the node on which the photo or video input through the user input unit is to be displayed;
a step C of displaying, by the display unit, the photo or video input through the user input unit on the node on which the photo or video input through the user input unit is to be displayed, using the node information of the upper node and the node information of the node on which the photo or video input through the user input unit is to be displayed, and
a step D of performing the steps A to C repeatedly for each of the plurality of the articles and the plurality of the storage places,
wherein the step C includes a step C-1 of displaying, by the display unit, a plurality of nodes on which photos or videos for the plurality of the articles and the plurality of the storage places are displayed in a tree structure, using the node information of the nodes on which the photos or videos for the plurality of the articles and the plurality of the storage places are to be displayed.

2. The method for managing articles of claim 1, wherein the step C further includes:
a step C-2 of receiving an input, by the user input unit, of selecting a photo or video displayed on a first node among the plurality of the nodes on which the photos or videos for the plurality of the articles and the plurality of the storage places are displayed, in the tree structure, and
a step C-3 of displaying, by the display unit, the photo or video displayed on the first node and a photo or video displayed on at least one of lower node connected to the first node, in an emphasized form.

3. The method for managing articles of claim 1, further comprising:
after the step D, a step E of switching a display mode, by the control unit, for the plurality of the nodes displayed in the tree structure based on a user's input through the user input unit, and subsequently displaying, by the display unit, the photos or videos for the plurality of the articles and the plurality of the storage places according to the switched display mode,
wherein the step E includes:
a step E-1 of switching the display mode, by the control unit, for the photos or videos of the plurality of the articles and the plurality of the storage places to a first mode based on a user's input through the user input unit;
a step E-2 of displaying, by the display unit, a photo or video displayed on at least one node that is located at a highest level among the plurality of the nodes displayed in the tree structure, and
a step E-3 of displaying, by the display unit, a photo or video displayed on at least one lower node that is connected to a selected node by a user's input through the user input unit among at least one node located at a certain level among all level including the highest level in the tree structure.

4. The method for managing articles of claim 1, further comprising:
after the step D, a step F of switching a display mode, by the control unit, for the plurality of the nodes displayed in the tree structure based on a user's input through the user input unit, and subsequently displaying, by the display unit, the photos or videos for the plurality of the articles and the plurality of the storage places according to the switched display mode,
wherein the step F includes:
a step F-1 of switching a display mode, by the control unit, for a photo or video displayed on a first node selected by the user, among the plurality of the nodes on which the photos or videos of the plurality of the articles and the plurality of the storage places are displayed, to a second mode based on the user's input through the user input unit, and
a step F-2 of displaying, by the display unit, a photo or video displayed on at least one upper node that is connected to the first node and the photo or video displayed on the first node in order of level.

5. The method for managing articles of claim 1, further comprising:
after the step D, a step G of switching a display mode, by the control unit, for the plurality of the nodes displayed in the tree structure based on a user's input through the user input unit, and subsequently displaying, by the display unit, the photos or videos for the plurality of the articles and the plurality of the storage places according to the switched display mode,
wherein the step G includes:
a step G-1 of switching a display mode, by the control unit, for a photo or video displayed on a first node selected by the user, among the plurality of the nodes on which the photos or videos of the plurality of the articles and the plurality of the storage places are displayed, to a third mode based on a user's input through the user input unit, and
a step G-2 of displaying, by the display unit, the photo or video displayed on the first node in a full screen, and
a step G-3 of switching to and displaying, by the display unit, a photo or video displayed on a node that is adjacent to the first node in a full screen based on a user's input through the user input unit.

6. The method for managing articles of claim 5, wherein in the step G-2 and the step G-3, an identification mark indicates whether a node that can be switched with the node on which the photo or video is displayed in the full screen, exists or not in a vertical and horizontal direction, and is provided on the top, the bottom, the left, and the right of the photo or video that is displayed in the full screen of the display unit.

7. The method for managing articles of claim 1, further comprising:
after the step D, a step H of editing a part of the plurality of the nodes displayed in the tree structure based on a user's input through the user input unit, and sequentially, displaying a photo or video for an article and a storage place according to node information of the edited part, wherein the step H includes:
a step H-1 of changing an upper node, by the control unit, of a first node selected by a user, among the plurality of the nodes on which the photos or videos of the plurality of the articles and the plurality of the storage places are displayed based on a user's input through the user input unit;
a step H-2 of changing node information, by the control unit, of the first node using node information of a changed upper node, and storing, by the storage unit, the changed node information of the first node, and
a step H-3 of displaying, by the display unit, the photos or videos for the plurality of the articles and the plurality of the storage places using node information of the changed upper node and changed node information of the first node.

8. The method for managing articles of claim 1, further comprising:
after the step D, a step I of editing a part of the plurality of the nodes displayed in the tree structure based on a user's input through the user input unit, and sequentially, displaying a photo or video for an article and a storage place according to node information of the edited part, wherein the step H includes:
a step I-1 of:
copying a photo or video, by the control unit, of a first node selected by a user, among the plurality of the nodes on which the photos or videos of the plurality of the articles and the plurality of the storage places are displayed based on a user's input through the user input unit;
creating a second node with the copied photo or video, and
changing an upper node of the second node;
a step 1-2 of changing node information of the second node using node information of the changed upper node, and storing, by the storage unit, the changed node information of the second node, and
a step 1-3 of displaying, by the display unit, the photos or videos for the plurality of the articles and the plurality of the storage places using the changed node information of the changed upper node and the changed node information of the second node.

9. The method for managing articles of claim 1, further comprising:
after the step D, a step J of editing a part of the plurality of the nodes displayed in the tree structure based on a user's input through the user input unit, and sequentially, displaying a photo or video for an article and a storage place according to node information of the edited part, wherein the step J includes:
a step J-1 of:
copying a photo or video, by the control unit, of a first node selected by a user, among the plurality of the nodes on which the photos or videos of the plurality of the articles and the plurality of the storage places are displayed based on a user's input through the user input unit;
creating a second node with the copied photo or video, and
changing an upper node of the second node;
a step J-2 of changing node information of the second node using node information of the changed upper node, and storing, by the storage unit, the changed node information of the second node;
a step J-3 of:
in case that a lower node connected to the first node exists, copying, by the control unit, a photo or video displayed on at least one of the lower node connected to the first node,
creating at least one third node to be connected to the second node,
changing node information of the at least one third node using the changed node information of the second node, and
storing, by the storage unit, the changed node information of the third node, and
a step J-4 of displaying, by the display unit, the photos or videos for the plurality of the articles and the plurality of the storage places using the changed upper information of the upper node, the changed node information of the second node, and the changed node information of the at least one third node.

10. The method for managing articles of claim 1, further comprising:
after the step D,
a step K-1 of receiving an input, by the user input unit from the user, of selecting a symbol tag that indicates a state of an article in a photo or video displayed on a first node among the plurality of the nodes on which the photos or videos of the plurality of the articles and the plurality of the storage places are displayed;
a step K-2 of updating, by the control unit, the photo or video displayed on the first node by inserting the symbol tag into the photo or video displayed on the first node, or creating tag information for the symbol tag selected for the photo or video displayed on the first node, and
a step K-3 of updating node information of the first node using the updated photo or video or the tag information, and sequentially storing, by the storage unit, the node information of the first node.

11. The method for managing articles of claim 1, further comprising:
after the step D,
a step L-1 of receiving an input, by the user input unit from the user, of selecting a photo or video displayed on a first node among the plurality of the nodes on which the photos or videos of the plurality of the articles and the plurality of the storage places are displayed, and
a step L-2 of updating, by the control unit, node information of the first node by inserting a notification tag for reminder function of an article shown in the photo or video displayed on the first node, and sequentially, storing, by the storage unit, the node information of the first node.
